(19) United States
(12) Patent Application Publication
(10) Pub. No.: US 2025/0164519 A1
(43) Pub. Date: May 22, 2025

(54) SYSTEMS AND METHODS FOR IONIZER MONITORING

(71) Applicant: Skyworks Solutions, Inc., Irvine, CA (US)

(72) Inventor: Arturo Alejandro Chavez Murga, Mexicali (MX)

(21) Appl. No.: 18/944,717

(22) Filed: Nov. 12, 2024

Related U.S. Application Data
(60) Provisional application No. 63/600,507, filed on Nov. 17, 2023.
(60) Provisional application No. 63/600,442, filed on Nov. 17, 2023.

(51) Int. Cl. G01P 3/481; H05F 3/06

(52) U.S. Cl. CPC G01P 3/481; H05F 3/06

(57) ABSTRACT

A system for detecting the operational status of one or more ionizers in a manufacturing environment is disclosed. The system comprises at least one magnetic sensor coupled with an ionizer to detect a magnetic field change. A microprocessor determines a revolutions per minute (RPM) value of the ionizer based on the output of the magnetic sensor and compares the RPM value with a predetermined threshold. When the RPM value drops below the predetermined threshold, the system generates a status signal that indicates the operational status of the ionizer is unhealthy.

### BACKGROUND

### Technical Field

Embodiments of this disclosure relate to ionization control in an electronics manufacturing environment and, more specifically, to operational status detection of ionizers.

### Description of Related Technology

It is well known that electronic devices can be zapped and destroyed by electrostatic discharge (ESD). ESD sparks occur in many different environments: A person walking on a carpeted floor can generate high-static voltages due to triboelectric charging, and voltages as high as 20 kV have been reported. Likewise, machines that use plastic parts can hold an electrostatic charge due to the plastic rubbing against other plastic parts. Typically, ESD results from static charges collecting on a surface. The surfaces of nonconductive materials develop equal and opposite charges when they come in contact, move against each other and then separate quickly. An electric field surrounds a nonconductive material once it is charged. Eventually, the amount of charge exceeds the insulating ability of the air and a spark jumps to a conductor or conductors close by.

The spark introduces currents in the conductor and can damage or destroy sensitive electronic devices. Many electronic components are sensitive to low electrostatic voltages and currents. Increasingly thinner layers in semiconductor devices have made ESD a growing threat. Therefore, in a conventional manufacturing environment for producing electronic devices, semiconductor components and printed circuit boards (PCBs), ESD has to be effectively controlled. An effective way is to ground conductors in the electrical components so that electricity generated by electrostatic can be drained. For example, some manufacturers provide a trace around a PCB edge to serve as a ground-connected guard trace. A PCB designed in such a way can be grounded during a manufacturing process by proper fixturing. When operators are involved, it is highly effective for he or she to wear a wrist strap that is connected to a ground lead to protect electronic components against ESD.

However, in many situations grounding is either hard or impossible. Moreover, grounding will not remove the static charge collected on nonconductive materials or insulators.

Conventionally, ionized air has been used to neutralize electrostatic charges in manufacturing environments for building electronics, especially on nonconductive materials. A commercially available air ionizer, when properly installed, can blanket the atmosphere or the benchtop with ionized air, which contains extremely large amounts of ions, resulting in nearly instantaneous static charge neutralization. The ionized air is characterized by balanced ions ensuring equal levels of positive and negative ions that can neutralize the electric charges on a nonconductive surface, including circuit board substrates, insulation tapes and other plastic materials, for example.

### SUMMARY

In one or more embodiments a system detects the operational status of one or more ionizers in a manufacturing environment. The system comprises at least one magnetic sensor coupled with an ionizer to detect a magnetic field change. A microprocessor determines a revolutions per minute (RPM) value of the ionizer based on the output of the magnetic sensor and compares the RPM value with a predetermined threshold. When the RPM value drops below the predetermined threshold, the system generates a status signal that indicates the operational status of the ionizer is unhealthy.

In other embodiments, a system for detecting an operational status of an ionizer comprises a magnetic sensor configured to detect a change of a magnetic field emitted from an ionizer, the magnetic sensor configured to produce an output signal reflecting a magnitude of the magnetic field. Circuitry is configured to receive the output signal and produce a status signal indicating the operational status of the ionizer.

In yet other embodiments, the magnetic sensor is a Hall effect sensor and the output signal from the Hall sensor is a voltage output. In further embodiments, the voltage output has characteristics of a sinusoidal wave. In yet further embodiments, the status signal is a binary signal configured to indicate a healthy status or an unhealthy status of the ionizer.

In some embodiments, the circuitry is configured to determine a revolutions per minute (RPM) value of the ionizer from the voltage output of the magnetic sensor and determine the binary signal by comparing the RPM value with a predetermined threshold. In other embodiments, the predetermined threshold is 750 RPM. In yet other embodiments, when the status signal indicates an unhealthy status, the status signal triggers an alarm.

In further embodiments, a microprocessor determines a revolutions per minute (RPM) value of the ionizer from the output signal of the magnetic sensor and determines the status signal by comparing the RPM value with a predetermined threshold. In yet further embodiments, the circuitry further comprises an optocoupler disposed between the microprocessor and an alarm. In some embodiments, the circuitry further comprises a relay disposed between the microprocessor and an alarm.

In additional embodiments, a method that detects an operational status of an ionizer comprises detecting a change of a magnetic field emitted from an ionizer with a magnetic sensor; and producing a status signal that indicates the operational status of the ionizer based on the change of the magnetic field.

In other embodiments, producing the status signal comprises determining a speed of the ionizer; and comparing the speed of the ionizer with a predetermined threshold. In yet other embodiments, the predetermined threshold is 750 RPM. In some embodiments, the status signal is a binary signal configured to indicate a healthy status or an unhealthy status of the ionizer.

In certain embodiments, the method further comprises generating a voltage output based on detecting the change of the magnetic field. In other embodiments, the voltage output has characteristics of a sinusoidal wave. In yet other embodiments, the method further comprises determining a revolutions per minute (RPM) value of the ionizer from the voltage output; and producing the status signal by comparing the RPM value with a predetermined threshold. In some embodiments, the method further comprises producing the status signal with a microprocessor that determines a revolutions per minute (RPM) value of the ionizer and compares the RPM value with a predetermined threshold.

In further embodiments, the method connecting an optocoupler between an output of the microprocessor and an alarm. In yet further embodiments, the method comprises connecting a relay between the microprocessor and an alarm.

In one or more embodiments, a system for detecting operational statuses of a plurality of ionizers comprises: a plurality of magnetic sensors for detecting a change of a magnetic field emitted from a plurality of ionizers, each of the plurality of magnetic sensors capable of producing an output signal; a multiplexer in communication with the plurality of magnetic sensors, the multiplexer configured to select at least one of the plurality of magnetic sensors; and a microprocessor configured to send an instruction to the multiplexer to select at least one of the plurality of magnetic sensors to produce a status signal indicating an operational status of at least one of the plurality of ionizers.

In other embodiments, each magnetic sensor corresponds to one of the plurality of ionizers. In yet other embodiments, the plurality of magnetic sensors are Hall effect sensors and output signals from the Hall effect sensors are voltage outputs. In further embodiments, the microprocessor in configured to instruct the multiplexer to periodically select and receive the output signal from each of the plurality of magnetic sensors.

In some embodiments, the status signal is a binary signal configured to indicate a healthy status or an unhealthy status of one of the plurality of ionizers being detected. In other embodiments, the status signal indicates the unhealthy status, the status signal is sent to trigger an alarm.

In further embodiments, the microprocessor is configured to determine a revolutions per minute (RPM) value of the ionizer being detected from the output signal of at least one of the plurality of magnetic sensors and determines the status signal by comparing the RPM value with a predetermined threshold. In yet further embodiments, predetermined threshold is 750 RPM.

In other embodiments, an optocoupler is disposed between the microprocessor and an alarm. In yet other embodiments, a relay is disposed between the microprocessor and an alarm.

In additional embodiments, a method for detecting operational status of a plurality of ionizers comprises: selecting a magnetic sensor from a plurality of magnetic sensors, the selected magnetic sensor corresponding to at least one ionizer of a plurality of ionizers, the selected magnetic sensor capable of detecting a change in magnetic field of the at least one ionizer; producing an output signal reflecting the change of the magnetic field of the at least one ionizer; producing a status signal from the output signal, the status signal reflecting the operational status of the at least one ionizer; and repeating the above acts for each of the plurality of ionizers.

In other embodiments, producing an output signal reflecting the change of the magnetic field of the corresponding ionizer comprises: determining a speed of the ionizer from the output signal; and comparing the speed with a predetermined threshold. In yet other embodiments, the predetermined threshold is 750 RPM. In some embodiments, the status signal is a binary signal configured to indicate a healthy status or an unhealthy status of the plurality of ionizers.

In further embodiments, the method further comprises generating a voltage output based on detecting the change of the magnetic field. In yet further embodiments, the voltage output has characteristics of a sinusoidal wave.

In other embodiments the method comprises determining a revolutions per minute (RPM) value of at least one of the plurality of ionizers from the voltage output; and producing the status signal by comparing the RPM value with a predetermined threshold. In yet other embodiments, the method further comprises producing the status signal with a microprocessor that determines a revolutions per minute (RPM) value of at least one of the plurality of ionizers and compares the RPM value with a predetermined threshold.

In further embodiments, the method comprises connecting an optocoupler between an output of the microprocessor and an alarm. In yet further embodiments, the method further comprises connecting a relay between the microprocessor and an alarm.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a schematic perspective view of an embodiment of an overhead ionizer.

FIG. 2 is a schematic perspective view of an embodiment of an ionizer.

FIG. 3 illustrates an embodiment of a Hall effect sensor disposed about an ionizer.

FIG. 4 is a schematic diagram of an embodiment of an ionizer status detection circuit comprising the Hall effect sensor of FIG. 4 and a microprocessor.

FIG. 5 is a perspective view of an embodiment of a printed circuit board (PCB) comprising the microprocessor of FIG. 4.

FIG. 6 is flowchart illustrating an embodiment of a method for determining the operational status of an ionizer based on output from a Hall effect sensor.

FIG. 7 is a schematic diagram of an embodiment of an electrical circuit for detecting the operational status of a plurality of (e.g., three) ionizers in parallel, comprising a Hall effect sensor for each ionizer to be detected, a microprocessor and a multiplexer.

FIG. 8 is a top perspective view of an embodiment of a printed circuit board comprising the microprocessor and the multiplexer of FIG. 7.

FIG. 9 is a schematic diagram of an embodiment of an electrical circuit taking the logical output from the circuit of FIG. 8 to trigger an alarm when the operational status of one or more ionizers is “False”.

FIG. 10 is flowchart illustrating an embodiment of a method for determining the operational statuses of a plurality of ionizers based on output from a plurality of respective Hall effect sensors.

### DETAILED DESCRIPTION

The following description presents various descriptions of certain embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

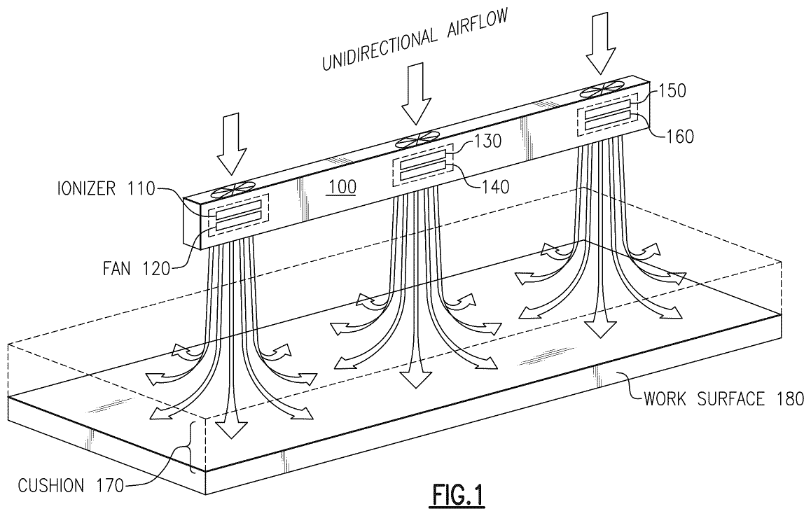

Referring to FIG. 1, a perspective view of an overhead ionized air blower 100 is illustrated to comprise three modules, each including an ionizer and a fan pair, 110 and 120, 130 and 140, 150 and 160. In each of the three modules, air is ionized by the ionizers 110, 130, 150 and blown by the fans 140, 150, 160 downward on to a cushion 170 which is disposed on a work surface 180, which can be part of a workbench. Stopped by the top surface of the cushion 170, the ironized air flows sideways forming a blanket of ionized air above the work surface 180. One advantage of blowing air downward is to suppress dust particles in the air toward the floor. This is important especially in a clean room environment. In certain embodiments, the ionized air blower 100 can include more or less than three ionizer and fan modules. A plurality of such ionized air blowers 100 can be implemented in a manufacturing environment, e.g., one over each workbench that processes electronic components or devices, or at least one over each station in a mass production line that produces electronics.

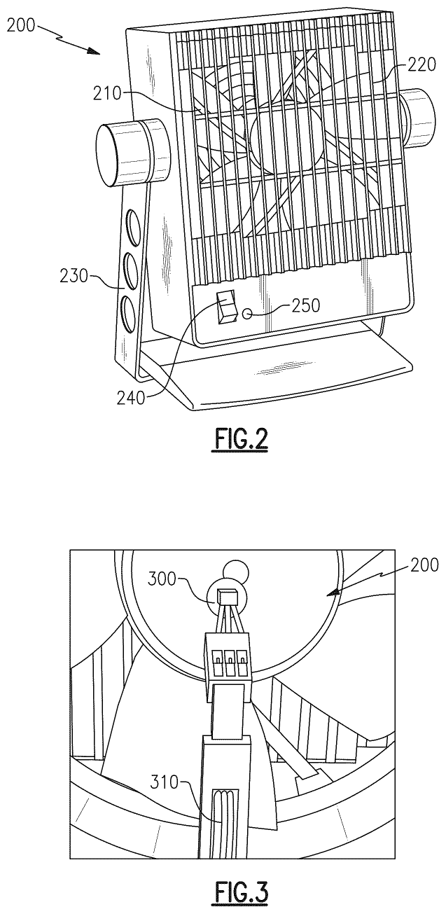

FIG. 2 is a perspective view of an embodiment of a ionizer 200. A main body of the ionizer 200 shown in FIG. 2 is a rectangular shaped box housing a fan 210 and guarded by a front grill 220. The ionizer 200 is supported by a stand 230, which can be placed on top of a surface. On a front face below the front grill 220 are located an on/off switch 240 and a signal light 250 configured to show a status of the ionizer 200. The ionizer 200, or other commercially available ionizers, comprises components in the housing to ionize air before the air is blown out by the fan 210. Combined with the fan power, the ionizer 200 can supply positive and negative ions to neutralize surfaces of nonconductors.

In a manufacturing environment, a plurality of ionizers, such as the ionizer 200, can be installed in places that are suitable to the ionized air blower 100 discussed previously. For example, one or more ionizers 200 can be installed at a pick-and-place station where electronic components are in contact with or moved by machine tools. Manufacturing stations, such as a pick-and-play station, typically need protection against electrostatic discharge (ESD). The ionizers 200 may be installed in an orientation so that ionized air is blown downward, to allow the ionized air impinging on surfaces that face substantially upward and to suppress dust particles toward the floor.

The effectiveness of electrostatic charge neutralization depends on the healthiness of the ionized air blower 100 or the ionizers 200. When a plurality of ionizers 200 are installed in a manufacturing area and run continuously, for example, over time some of the ionizers 200 may suffer from quality issues and can stop or slow down. Without a properly implemented quality assurance plan to ensure the healthiness of the installed ionizers 200, failure of an ionizer 200 on a manufacturing line will cause the parts or devices produced from the line to be potentially exposed to ESD. The exposed parts or devices will need to be either quarantined or tested more rigorously to screen out potential failures.

The problem is even more profound if an ionizer 200 remains running but at a lower efficiency. It is known that the quantity of ions delivered to a work surface is related to the speed of the fan in the ionizer 200. The slower the fan speed, the less the quantity of ions delivered. Also, when an ionizer 200 that is observed to run slower than an established fan speed threshold, it is hard to determine how long this has occurred. When the ionizer fan 210 is slower than a certain threshold, the quantity of ions delivered to the work surface may be too low to neutralize the work surface.

Therefore, there is need to detect the healthiness of each ionizer 200 or ionized air blower 100 installed in a manufacturing line. Different methods can be adopted. Because the speed of airflow can be influenced by multiple factors, e.g., ventilation system, airflow speed measurement is not a direct measurement of the fan speed. Some tests may involve sampling air and test the sampled air for ions. This type of test, however, is complicated and costly. The time span between tests may be too long, and sample locations may be too sparce for high standard quality assurance.

In another approach, the speed of airflow can be measured using a transducer placed near the ionizer fan 210. Referring to FIG. 3, a Hall effect sensor 300 is disposed about an ionizer 200 near the ionizer fan 210 to measure the speed of the fan rotation, e.g., revolutions per minute (RPM). In the figure, the Hall effect sensor 300 is attached to a backside of the ionizer fan 210. But the Hall effect sensor 300 can be disposed in other locations such as close to the backside of ionizer 200. The Hall effect sensor 300 can also be placed laterally at a side, at the front side or on top of the ionizer 200, either attached or not attached to the ionizer 200, as long as measured output can be used to derive the speed of the fan 210.

The fan 210 of the ionizer 200 are driven by a motor (not shown) disposed at the center of the fan 210. The motor (not shown) is driven by a moving magnetic field which is generated by an electrical current. The change of magnetic field can therefore be measured by a magnetic sensor, e.g., the Hall effect sensor 300 as shown in FIG. 3 and described above. The Hall effect sensor 300 can sense or detect a change of a magnetic field and produce an output voltage signal that reflects the change of magnetic field change.

During each rotation of the fan 210, the magnetic field in the space around the motor (not shown) and the fan will change. Depending on the location where the magnetic sensor, e.g., the Hall effect sensor 300, is placed, the output signal may show different characteristics but will demonstrate periodical signatures corresponding to the rotation of the fan 210. In some embodiments, the output signal from the Hall effect sensor 300 may be a sinusoidal curve with time, with one period corresponding to a complete rotation of the fan. In some embodiments, the output signal from the Hall effect sensor 300 may be a triangular shaped curve, with one period corresponding to a complete rotation the fan 210. Other characteristics of periodical output curves are possible depending on the location where the Hall effect sensor 300 is positioned and the structure of the motor, including is a permanent magnet is disposed in the motor. For example, it is possible for an output voltage curve to have double peaks and/or double valleys.

Since the output signal curve from the Hall effect sensor 300 has periodical characteristics corresponding to rotations or revolutions of the fan 210 measured, it is possible to determine the speed, e.g., revolutions per minute (RPM), of the fan 210. If the output signal curve is a sinusoidal curve with a period corresponding to a revolution of the fan 210, for example, the RPM of the fan is equal to the frequency of the output signal curve.

Further, it is possible to establish a correlation between the speed of fan 210 and the density of ions of the ionized air blanketing a work surface where an ionizer 200 is placed. This can be done by repeating measurements of the fan speed using the Hall effect sensor 300 and ion density in the air using an ion counter at the work surface simultaneous when the fan speed is adjusted to multiple levels. It is known the higher fan speed will deliver more balanced ions to the work surface.

For a newly installed ionizer 200, the fan speed may run within a product specification range, e.g., 2000-3000 RPM for certain models. However, as time goes by ionizers 200 placed in a manufacturing environment become aged. Some of the ionizers may start to fail and stop working. Other ionizers may experience slower fan speed and deliver less ionized air. As the fan speed decreases, and at some point goes below a threshold, the delivered ionized air may not be enough to neutralize static charge.

Therefore, there is need to determine a threshold of the fan speed below which the ion density in the air at the work surface is too low for sufficient static charge neutralization. The predetermined threshold may be established from testing, experience, or suggestion from the vendor of the ionizer that is implemented on the manufacturing line. For example, for an ionizer 200 having a fan speed product specification range of 2000-3000 RPM, the threshold may be about 750 RPM, or in the range between 500-1000 RPM, e.g., 500, 550, 600, 650, 700, 750, 800, 850, 900, 950, or 1000 RPM. The threshold may be dependent on the model of the ionizer 200 and quality assurance requirements on a specific manufacturing line. It may be below 500 RPM or above 1000 RPM. When the fan speed of an ionizer 200 in a manufacturing area is detected below the predetermined threshold, the ionizer 200 is considered faulty and needs to be replaced or repaired.

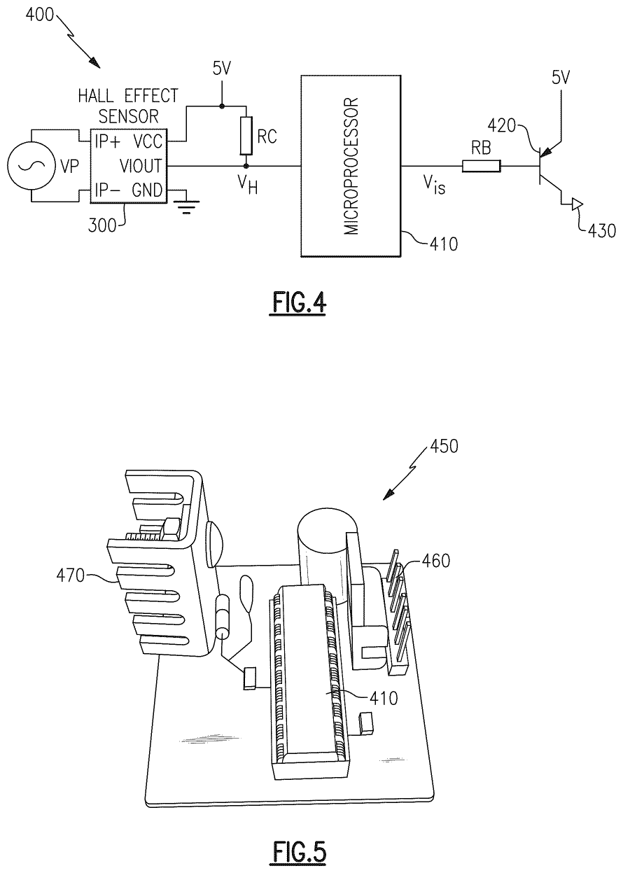

Referring to FIG. 4, a schematic diagram of a circuit 400 (e.g., circuitry) comprising a Hall effect sensor 300 is shown. The Hall effect sensor 300 detects the change of a magnetic field generated by magnet(s) in the motor of the ionizer 200, and outputs a voltage signal V_{H} which varies with time corresponding to the change of the intensity of the magnetic field emitted from the ionizer 200. The circuit 400 of FIG. 4 further comprises a microprocessor 410 which is connected to the Hall effect sensor 300 to receive and process the voltage signal V_{H} from the Hall effect sensor 300. The microprocessor 410 outputs a voltage signal Vᵢₛ indicating the operational status of the ionizer 200. In some embodiments, the status signal Vᵢₛ is a binary logic signal reporting either a logic high level or a value “true”, or a logic low level or a value “false”. Since the purpose the circuit 400 is to detect if an ionizer is faulty, a logic value “true” may mean that the ionizer is at a faulty operational status, and a logic value “false” may mean that the ionizer 200 is not faulty.

In FIG. 4, the output signal Vᵢₛ from the microprocessor 410 is further coupled to a transistor 420 to trigger an alarm. When the microprocess 410 receives the output voltage signal V_{H} from the Hall effect sensor 300 and determines that speed of the fan in the detected ionizer 200 is below the predetermined threshold. The microprocessor 410 flags the ionizer 200 as faulty and produces a logic high level or “true” value, and deliver the signal to turn on the transistor 420, which in turn sends a signal 430 to trigger or set off an alarm. The alarm can be the on the ionizer 200, e.g., the signal light 250 shown in FIG. 2, or an alarm on the manufacturing floor. Warned by the alarm, a user, e.g., a manufacturing engineer or a quality control engineer, can act to timely replace or repair the faulty ionizer 200.

FIG. 5 is a printed circuit board (PCB) 450 comprising certain components shown in the circuit 400 of FIG. 4, including the microprocessor 410. The Hall effect sensor 300 is configured to be connected to connector pins 460 on the PCB 450. The PCB 450 further comprises other components, including capacitors for DC input voltage regulation and a heat sink 470 to dissipate heat generated on the PCB 450.

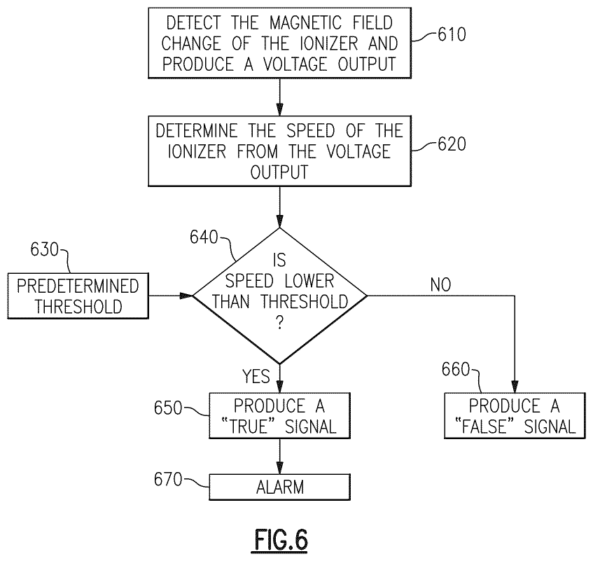

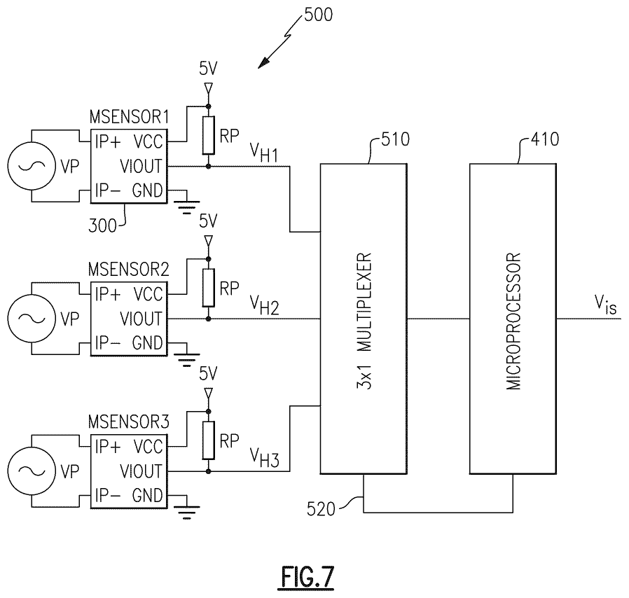

As described above, the microprocessor 410 receives the output voltage signal V_{H} from the Hall effect sensor 300 and produces a binary logic signal Vᵢₛ to indicate the operational status of the ionizer 200 being detected. The microprocessor 410 is programmed to carry out such actions. The method or algorithm for detecting the magnetic field change of an ionizer 200 using the Hall effect sensor 300 and determining the logic signal Vᵢₛ from output voltage signal V_{H} from the Hall effect sensor 300 is illustrated by the flowchart in FIG. 6. The method starts at a step 610 to detect magnetic field change of the ionizer 200 using a Hall effect sensor 300 and produce a voltage output V_{H} reflecting the magnetic field change. At the next step 620, the speed of the ionizer fan 210, e.g., RPM, is determined from the voltage output V_{H} from the Hall effect sensor 300. Then at step 640, the fan speed is compared to a predetermined threshold from step 630 to decide if the speed is lower than the threshold. As described above, for an ionizer having specified rang speed range 2000-3000 RPM, the threshold may be 750 RPM, or between 500-1000 RPM. If the answer of step 640 is yes, a “true” or logical high signal is produced to trigger or set off an alarm, see step 670. Otherwise, if the answer is no, a “false” or logic low signal is produced. As described above, warned by the alarm, a user, e.g., an engineer on the manufacturing floor, can act to timely replace or repair the faulty ionizer 200 to avoid quality fallout.

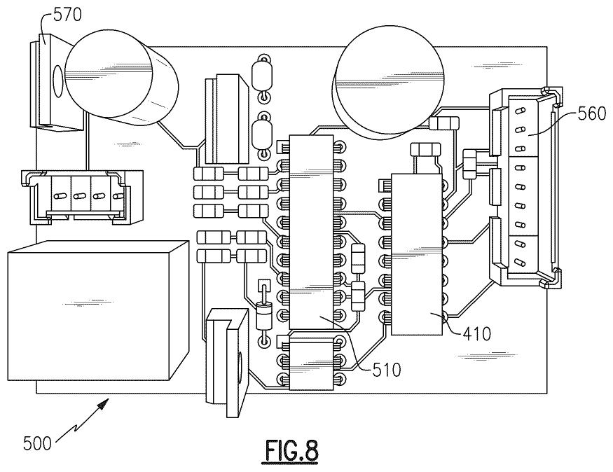

A manufacturing floor may have a plurality of ionizers 200 installed. These plurality of ionizers may be detected in parallel and processed by one microprocessor. FIG. 7 shows a circuit 500 (e.g., circuitry) comprising three Hall effect sensors 300, Msensor 1, Msensor 2, and Msensor 3, detecting 3 ionizers 200 respectively. A 3×1 multiplexer 510 is disposed between the three Hall effect sensors 300 and the microprocessor 410, taking the output voltage signals, V_{H1}, V_{H2}, and V_{H3}, from the three connected Hall effect sensors 300 and deliver an output voltage to the microprocessor 410. Although the circuit 500 in FIG. 7 comprises a 3×1 multiplexer connected to three Hall effect sensors 300 to detect the operational statuses of three ionizers 200 respectively, the circuit 500 can be shrunk to include a 2×1 multiplexer that is connected to two Hall effect sensors 300 to detect the operational statuses of two ionizers 200 respectively. In other embodiments, the circuit 500 can also be expanded to include a 4×1 multiplexer, an 8×1 multiplexer, a 16×1 multiplexer, a 32×1 multiplexer, or another type of N×1 multiplexer, that is connected to a corresponding number of Hall effect sensors 300 to detect the operational statuses of a corresponding number of ionizers 200.

In FIG. 7, the microprocessor 410 is connected to a select line, e.g., two select lines, 520 on the 3×1 multiplexer 510, sending a command to actively select one of the voltage signals, V_{H1}, V_{H2}, and V_{H3}, from the three connected Hall effect sensors 300. The selection can be programmed to select one of the three voltage signal lines automatically and periodically, e.g., sequentially selecting the three voltage signals, V_{H1}, V_{H2}, and V_{H3} in a period from once per one second to once per 10 minutes. In other embodiments, the selection can be done manually, for example, through a control panel or a touch screen connected to a computing device, e.g., a computer or a mobile device. For example, when the voltage signal V_{H1} from Msensor 1 is selected, the 3×1 multiplexer 510 takes the voltage signal V_{H1} as input and outputs the same voltage signal V_{H1} to the microprocessor 410. The microprocessor 410 then processes the voltage signal V_{H1} to determine the operational status of the ionizer 200 detected by the Hall effect sensor 300, e.g., Msensor 1, that the voltage signal V_{H1} is received from, and produces an output signal Vᵢₛ indicating the operational status of the detected ionizer 200. The next moment, the voltage signal V_{H2} from Msensor 2 is selected, and the microprocessor 410 takes the signal signal V_{H2} to decide the operational status of the detected ionizer 200.

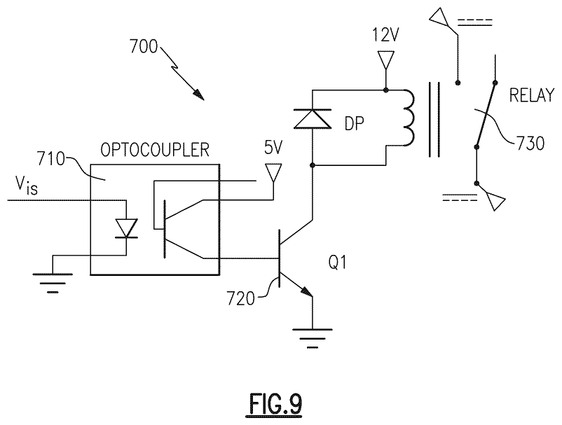

In FIG. 8 a PCB 550 is shown comprising at least part of the components shown in FIG. 7, including the multiplexer 510 and the microprocessor 410. The Hall effect sensors 300 are configured to be connected to a column of connector 560 on the PCB 550. The PCB 550 further comprises capacitors, microchips, and heat sinks 570 which are configured to dissipate heat generated from the electronic components on the PCB.

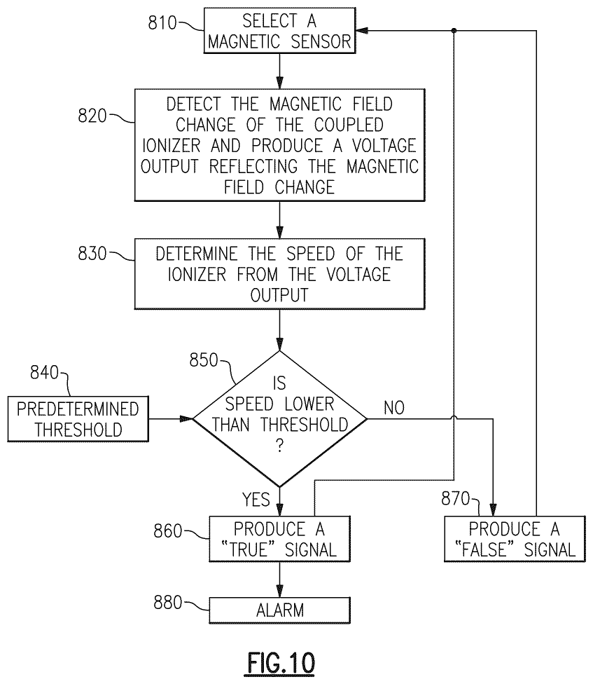

In FIG. 9, a circuit 700 takes the logic signal Vᵢₛ outputted from the circuit 500 of FIG. 7 and to set off an alarm when the logic signal indicates that the detected ionizer 200 is at the faulty operational status. FIG. 9 comprises an optocoupler 710 which is dispose before a transistor 720, receiving the logic signal Vᵢₛ and deliver to the transistor 720. On a manufacturing floor, an electrical signal may not be stable. The optocoupler 710 can decouple and eliminate noise from the circuit 500 and pass a reliable logic signal Vᵢₛ to a transistor 720, and to a normally open relay 730. When the logic signal Vᵢₛ is “true”, e.g., the detected ionizer 200 is faulty, the transistor 720 is switched on to close the relay 730. Consequently, an alarm connected to the relay is set off. In some embodiments, the alarm can be an acoustic alarm on the manufacturing floor that can drain a substantially large electrical current. The relay 730 can allow a small electrical current from the transistor 70 to operate the alarm that may have a significantly higher current load. In some embodiments, the alarm can be the signal light 250 on the ionizer 200 in FIG. 2. In this case, a 1×3 multiplexer can be disposed in the circuit 700 to direct the logic signal Vᵢₛ to the Hall effect sensor 300 being detected.

The method of operating the circuit 500 of FIG. 7 for detecting the operational statuses of three ionizers 200 using three Hall effect sensors 300 is illustrated by the flowchart in FIG. 10. The method starts at a step 810 to select one of the Hall effect sensors 300. At step 820, the magnetic field change of the ionizer 200 coupled to the selected Hall effect sensor 300 is detected, generating a voltage output to reflect the magnetic field change. At the next step 830, the speed of the fan of the coupled ionizer 200 is determined from the voltage output from the Hall effect sensor 300. Then at step 850, the fan speed is compared to a predetermined threshold from step 840 to decide if the speed is lower than the threshold. If the answer of step 850 is yes, a “true” or logical high signal is produced, see step 860. Otherwise, if the answer is no, a “false” or logic low signal is produced, see step 870. A “true” logic signal will set off an alarm, see step 880. As described above, warned by the alarm, a user, e.g., an engineer on the manufacturing floor can act to timely replace or repair the faulty ionizer 200. Then the method goes back to step 810 to select another Hall effect sensor 300 and repeat step 820 to step 870 or step 880.

According to the embodiments of systems and methods disclosed, faulty ionizers in a manufacturing area, including the ones that stops working and the ones that slow down below a predetermined speed threshold, can be detected almost instantly. Warned by an alarm of a faulty ionizer, a user, e.g., a quality engineer, a manufacturing engineer, or a technical in the area, can timely act to replace or repair the ionizer. As such, exposure to ESD of electronic components or devices processed in the manufacturing area can be effectively controlled.

Aspects of this disclosure can be implemented in different areas to detect operational statuses for various electronic devices, as long as the electronic devices have rotational movements. Periodical changes of magnetic field can be from an electrical motor or magnets attached on rotational objects.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A system for detecting operational statuses of a plurality of ionizers comprises:
a plurality of magnetic sensors for detecting a change of a magnetic field emitted from a plurality of ionizers, each of the plurality of magnetic sensors capable of producing an output signal;
a multiplexer in communication with the plurality of magnetic sensors, the multiplexer configured to select at least one of the plurality of magnetic sensors; and
a microprocessor configured to send an instruction to the multiplexer to select at least one of the plurality of magnetic sensors to produce a status signal indicating an operational status of at least one of the plurality of ionizers.

2. The system of claim 1 wherein each magnetic sensor corresponds to one of the plurality of ionizers.

3. The system of claim 1 wherein the plurality of magnetic sensors are Hall effect sensors and output signals from the Hall effect sensors are voltage outputs.

4. The system of claim 1 wherein the microprocessor in configured to instruct the multiplexer to periodically select and receive the output signal from each of the plurality of magnetic sensors.

5. The system of claim 1 wherein the status signal is a binary signal configured to indicate a healthy status or an unhealthy status of one of the plurality of ionizers being detected.

6. The system of claim 5 wherein when the status signal indicates the unhealthy status, the status signal is sent to trigger an alarm.

7. The system of claim 1 wherein the microprocessor is configured to determine a revolutions per minute (RPM) value of one of the plurality of ionizers being detected from the output signal of at least one of the plurality of magnetic sensors and determines the status signal by comparing the RPM value with a predetermined threshold.

8. The system of claim 7 wherein the predetermined threshold is 750 RPM.

9. The system of claim 1 further comprising an optocoupler disposed between the microprocessor and an alarm.

10. The system of claim 1 further comprising a relay disposed between the microprocessor and an alarm.

11. A method for detecting operational status of a plurality of ionizers comprises:
selecting a magnetic sensor from a plurality of magnetic sensors, the selected magnetic sensor corresponding to at least one ionizer of a plurality of ionizers, the selected magnetic sensor capable of detecting a change in magnetic field of the at least one ionizer;
producing an output signal reflecting the change of the magnetic field of the at least one ionizer;
producing a status signal from the output signal, the status signal reflecting the operational status of the at least one ionizer; and
repeating the above acts for each of the plurality of ionizers.

12. The method of claim 11 wherein producing an output signal reflecting the change of the magnetic field of the at least one ionizer of the plurality of ionizers comprises:
determining a speed of the at least one ionizer of the plurality of ionizers from the output signal; and
comparing the speed with a predetermined threshold.

13. The method of claim 12 wherein the predetermined threshold is 750 RPM.

14. The method of claim 11 wherein the status signal is a binary signal configured to indicate a healthy status or an unhealthy status of the plurality of ionizers.

15. The method of claim 11 further comprising generating a voltage output based on detecting the change of the magnetic field.

16. The method of claim 15 wherein the voltage output has characteristics of a sinusoidal wave.

17. The method of claim 15 further comprising:
determining a revolutions per minute (RPM) value of at least one of the plurality of ionizers from the voltage output; and
producing the status signal by comparing the RPM value with a predetermined threshold.

18. The method of claim 11 further comprising producing the status signal with a microprocessor that determines a revolutions per minute (RPM) value of at least one of the plurality of ionizers and compares the RPM value with a predetermined threshold.

19. The method of claim 18 further comprising connecting an optocoupler between an output of the microprocessor and an alarm.

20. The method of claim 18 further comprising connecting a relay between the microprocessor and an alarm.
